(19) United States
(12) Patent Application Publication
(10) Pub. No.: US 2006/0179900 A1
(43) Pub. Date: Aug. 17, 2006

(54) Vending machine lock with motor controlled slide-bar and hook mechanism and electronic access

(75) Inventors: William D. Denison, Lake Zurich, IL (US); Gary L. Myers, Monee, IL (US); Richard Paeth, St. Charles, IL (US); Catalin Captarencu, Wheeling, IL (US); Calin V. Roatis, Long Grove, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: TriTeq Lock and Security, L.L.C., Elk Grove, IL (US)

(21) Appl. No.: 11/102,439

(22) Filed: Apr. 8, 2005

Related U.S. Application Data
(60) Provisional application No. 60/618,069, filed on Oct. 12, 2004.

(51) Int. Cl. E05B 65/00

(52) U.S. Cl. 70/77

(57) ABSTRACT

An enhanced slide and hook locking mechanism control system for vending machines and the like that utilizes a reversible motor and worm gear drive that operates the slide and hook mechanism. The worm drive is coupled to the slide through a crankshaft type of interconnection. Or as alternatives, the slide means can be gear driven or it may be connected using push-pull type of cable or rod. An electronic control with a microcomputer interface drives the motor control and the system may be operated by a keypad or a remote wireless control device.

### RELATED APPLICATIONS

This application claims priority to U.S. Provisional Application No. 60/618,069, filed Oct. 12, 2004, and incorporates the same by reference in its entirety. It is also related to U.S. Provisional Application No. 60/550,801, filed Mar. 5, 2004, now application Ser. No. 11/073,184, filed Mar. 3, 2005.

### FIELD OF THE INVENTION

The present invention relates generally to vending machine lock systems that control the movement of the slide and hook mechanism such as in a conventional snack food or glass-front vending machine. More specifically the invention provides an enhanced slide mechanism control, and it may also incorporate a unique access control device such as a keypad access control and/or a remote control device that transmits codes in a wireless medium.

### BACKGROUND OF THE INVENTION

Snack food and glass-front vending machines today are typically secured with a mechanism comprising of a slide-bar and hooks or the like in the door, which generally extend into the cabinet frame when locked, the motion going from unlocked to locked is typically controlled by a rotateable exterior mounted handle controlled by a mechanical T-handle mechanism, see Minemura U.S. Pat. No. 4,993,247. The handle is prevented from rotating by a mechanical core lock. For example, a slide-bar configuration consisting of one or more bars that is in a retracted position while the door is open and as the door is being closed. Once the door is in the closed position, the operator takes the handle and rotates it typically 90 or 180 degrees (depending on the geometry of the hooks) and the hooks will extend into the catches in the cabinet. To unlock, first the access control device is accessed, the slide-bar and the hooks are moved retracted from the catches, and last the handle is pulled so the door will open. These methods are typically cumbersome and time consuming. In addition, an enclosure as described above will typically have an unattractive looking handle and dial or keypad lock mounted to the exterior of the door.

The object of this invention is to improve on the methods, operation, and the interface of the vending machine locking and the unlocking as described above. In addition, the removal of certain components from the outside of the enclosure door will add to the improvements mentioned by providing enhanced security due to a more difficult point of attack and also provide additional exterior surface area to add decorative features to the vending machine door.

This invention is not limited to any particular type, style or application of the enclosure. In addition, although the preferred embodiment of the invention will describe a door with slide bar and hook mechanism interfacing to catches in the cabinet of the enclosure, this invention will also support the opposite arrangement such as a slide bar and hook mechanism in a cabinet that interface into catches in the doorframe, as well as many other types of door, cabinet, and mechanisms arrangements as are available. This invention will also support the opposite mechanism arrangement such as (for example) a motor controlling a slide bar consisting of catches (instead of hooks) which would latch and un-latch into one or more hooks (instead of catches). A cable or rod may be used to interface the lock mechanism to the slide bar. In the case of a rod being used it can also be modified to act as the latch itself.

### BRIEF SUMMARY OF THE OBJECTS OF THE INVENTION

The first object is to improve the locking and unlocking of the door by removing the need for a handle interfaced to a slide-bar hook mechanism.

The second object is to replace manual movement of the slide-bar with motor control movement of the slide-bar.

The third object is to provide a less user interactive procedure and an easier interface to access and lock the vending machine.

The forth object is to provide a faster method for accessing and locking the vending machine.

The fifth object is to improve the security of the door and remove the point of attack by removing the need for an access control unit (T-handle and lock core) from the door and replace with an electronic remote or removable keypad transmission device.

The sixth object is to provide a more user-friendly electronic controlled device to access and lock the door.

The seventh object is to provide the above-described features with a device that is battery powered, although the invention is not limited to battery controlled operation.

### BRIEF DESCRIPTION OF THE DRAWINGS

FIG. 1 is an elevational view of the present motor-controlled slide-bar mechanism together with broken out and detail enlarged views taken along the line C-C and for the area D and here showing how it interfaces to the lock-bar;

FIG. 2 is a front plan view of the motor controlled slide-bar mechanism locking system;

FIG. 3 is an exploded view of the motor and drive for the controlled slide-bar mechanism locking system;

FIG. 3 A is a perspective view of an alternate configuration of the mechanism showing how the helical gear can act as a direct interface for the slide assembly;

FIG. 3B is a perspective view of an alternate configuration of the mechanism showing a contained drive system;

FIG. 4 is a perspective view showing a rod or wire interconnection;

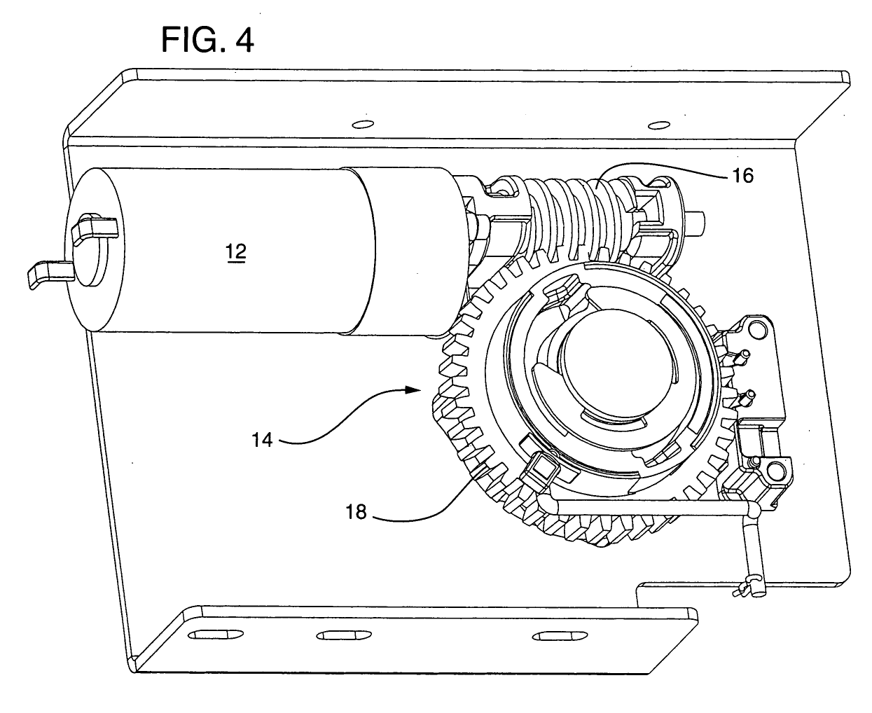

FIG. 5 is a perspective view showing yet another alternate construction and interconnection system as it would be typically installed into a vending machine;

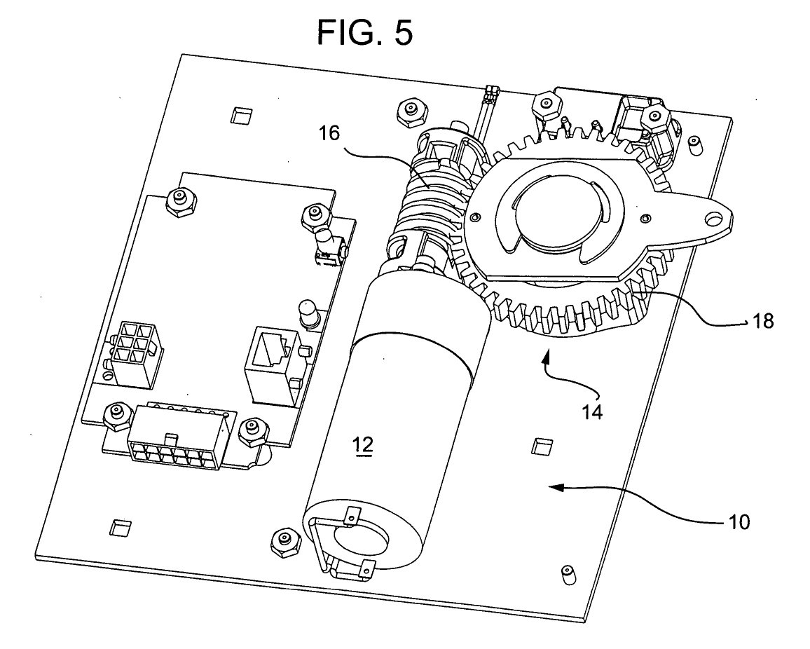

FIG. 6 is a flowchart of the locked to unlock operation;

FIG. 7 is a flowchart of the unlock to lock operation;

FIG. 8 is a flowchart of locked to unlocked with optional receiver sensor; and

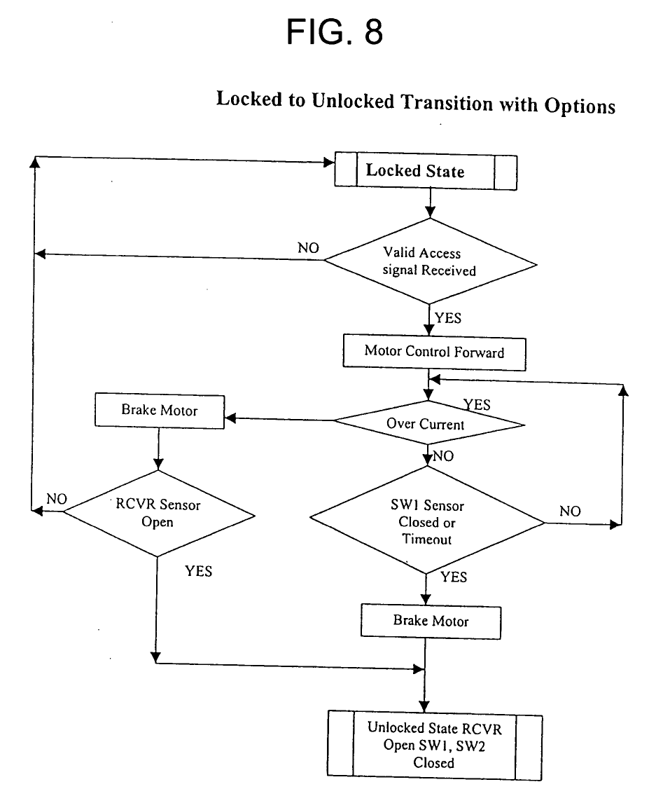

FIG. 9 is a flowchart of unlocked to locked with optional receiver sensor.

### DETAILED DESCRIPTION OF THE INVENTION

The prior art is illustrated in U.S. Pat. No. 4,993,247. It would typically consist of a T-handle, a slide-bar mechanism, and the interface of these components. Electronic locking systems are shown in Roatis et al. U.S. Pat. Nos. 6,581,986 and 6,575,504, for example, as used with ordinary lighted doors used on vending machines. Glass front doors can use a locking system similar to a school locker wherein a sliding bar having slots or hooks engage with complimentary slots or hooks.

This invention consists primarily of a motor controlled mechanism to control the movement of the slide-bar mechanism 8 in a vending machine or the like; an electronic control interface to the motor mechanism, an access control device, and a power source.

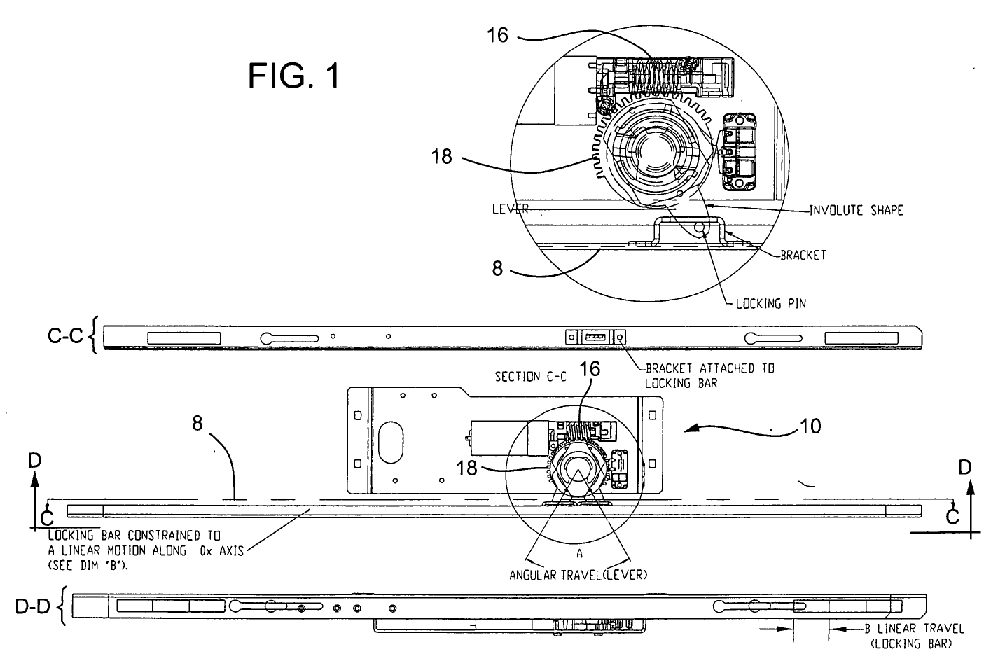

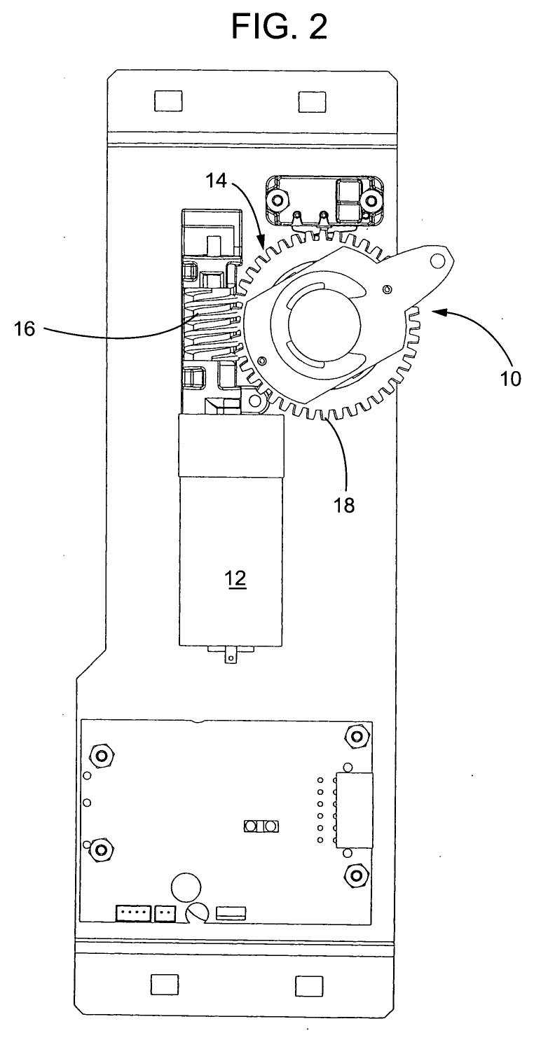

The motor controlled mechanism 10 is shown in drawing FIGS. 1, 2, 3, 3A and 3B. It serves to eliminate the handle drive system in vending machines, as they exist today. The motorized lock 10 provides a motor 12 to gear reduction 14 system that allows adequate power to control and move the mechanism, and also will hold back several hundreds of pounds of pry pressure if a vandal were to attempt to pry or force a locked mechanism back to the unlocked position by using a pry bar or other tool to push the extended slide-bar back to the retracted position. This is accomplished by gear reducing the motor rotation first through smaller metal gears in the motor mounted gearbox then to a worm-gear 16 to helical gear arrangement 18. The helical gear 18 is interfaced to at least 2 teeth of the worm gear 16 to hold back a considerable force from an external device which tries to push in the mechanism and slide-bar. The interconnection between the helical gear 18 and the slide bar 8 is shown in FIGS. 1 thru 3a are representative of a variety of connections available. All known other crankshaft type of mechanisms are applicable to this type of drive.

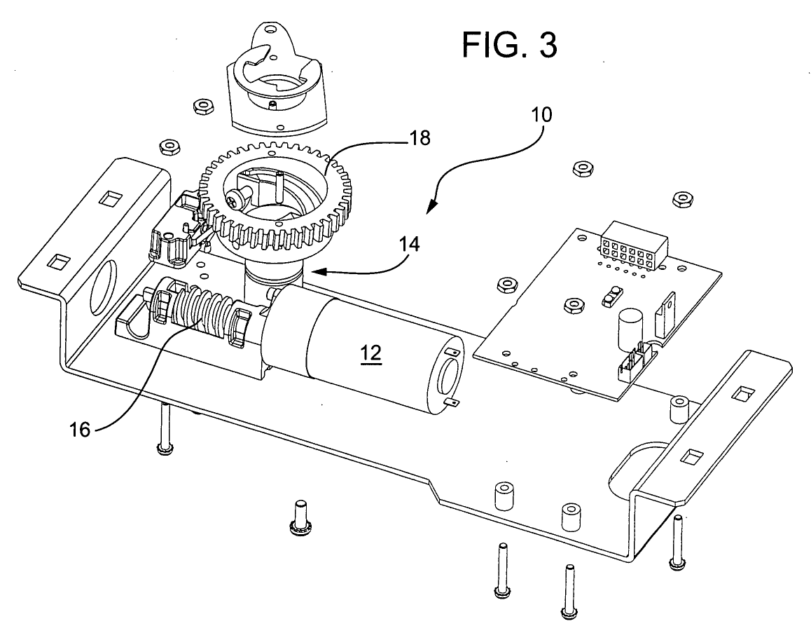

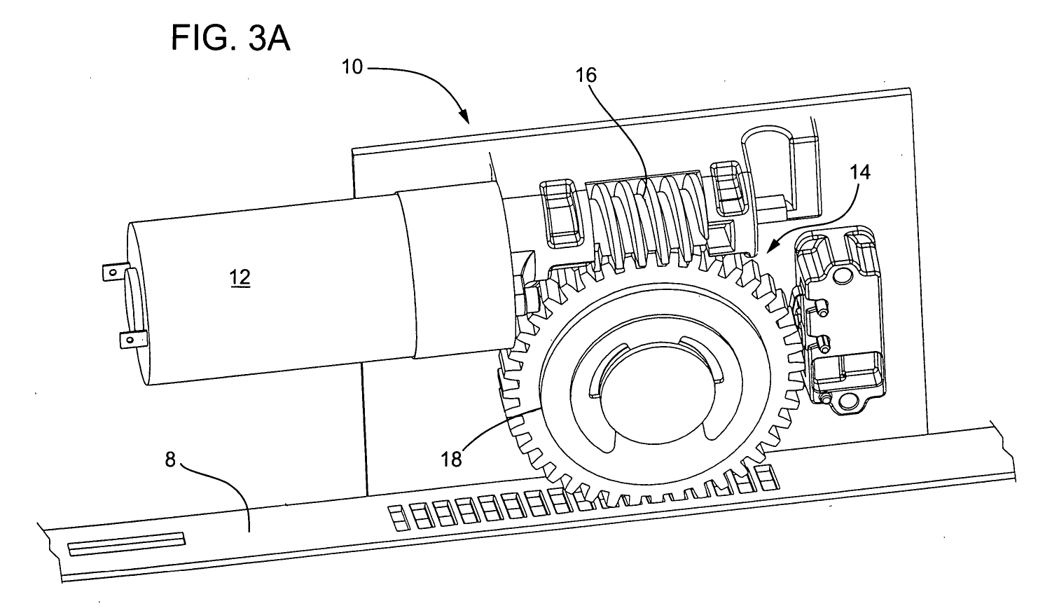

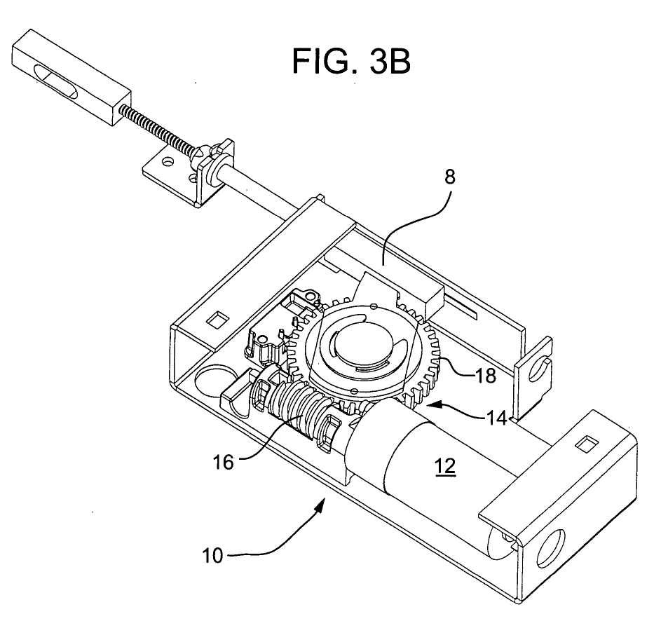

The motor control can also interface into a cable or rod drive system 8 as shown in FIG. 3B. This type of drive allows the mechanism to be placed in a vending machine or the like in a variety of positions where space or direct access to the slide bars is not readily available. The rod as shown can be replaced using a conventional push-pull cable apparatus. The rod or cable assembly can be housed in such a manner as to allow the lock mechanism to be packaged as a singular assembly. This becomes an issue when trying to mount the lock drive unit in snack food vendors. These machines typically do not have access that allows direct connection from the crankshaft drive of the gear assembly

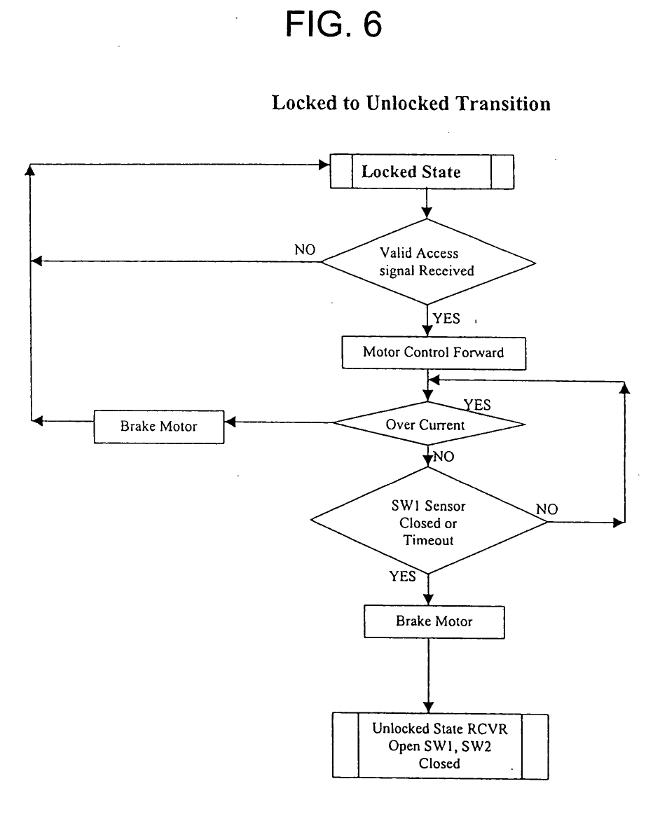

In accordance with the present invention, an electronic control interfaces to the motor 12 and position switches of the motor mechanism. It will control the mechanism by a microcomputer by either driving the mechanism motor in two directions (forward and reverse) or a single direction to move the slide-bars in and out of the locked position (retracted and extended). The flow-chart drawings 6 and 7 shows a mechanism control using forward/reverse motor control and position sensors. Both the locking and unlocking modes of operations are triggered by a signal from the access control device and the controller operates the motor per the sensor switches, motor current monitoring, and timers as described. The flow-chart drawings 8 & 9 describe locking and unlocking modes of operation if a door-closed and/or a receiver switch sensor is used to detect the door in the closed position to automatically trigger the locking sequence. As in FIGS. 6 & 7, the controller operates the motor per the sensor switches, motor current monitoring, and timers as described.

A further feature considers general safety of the lock operation, when the motor control unit attempts to energize the motor in order to move the slide-bar in either the locked or unlocked position and if either a slide-bar impediment or a door jam or a shorted motor condition occurs where the motor current crosses a certain limit to indicate the slide-bar is not moving, the motor control unit senses this condition and ceases to drive the motor. If this occurs at the beginning of the lock cycle (within approximately the first 30 degrees of gear rotation) the motor control unit will measure this and if it senses that the slide-bar is jammed from moving, the motor could be reversed in order to return the mechanism back to the fully retracted position. After 30 degrees of gear movement if the motor current is exceeded, the motor control will simply de-energize the motor and will not attempt to reverse the movement of the slide-bar, thus the enclosure door will remain in the locked position. If an unlock signal is later received, the motor controller will proceed to retract the slide-bar and unlock the vending machine.

In the event that a position switch is faulty, the controller is programmed with fault tolerant or default control logic to control the mechanism and allow the door to unlock if in fact a correct access code is received, even if the mechanism sensing is faulty.

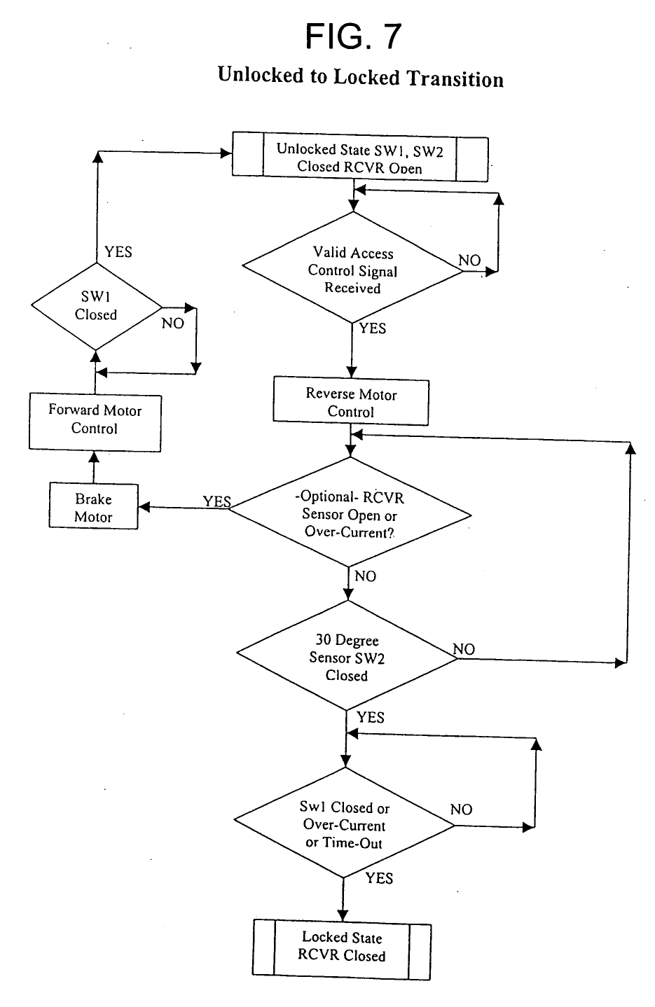

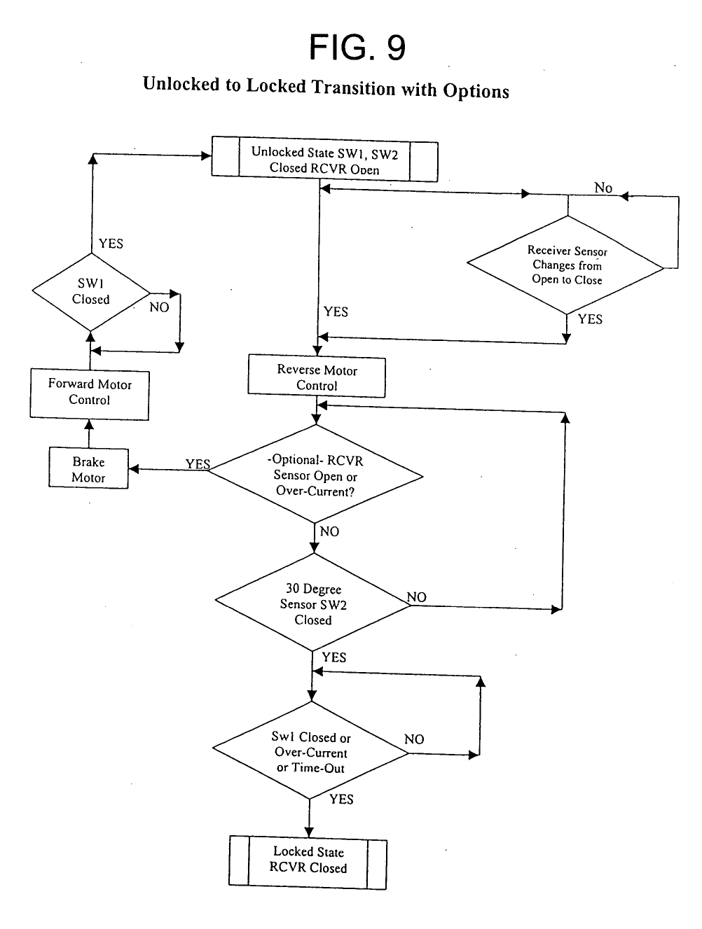

As described in FIG. 7, in the preferred embodiment the locking event for the vending machine door is controlled by an access signal from the access control unit. In an alternative embodiment as described in FIG. 9, locking is triggered by a simple position switch which measures the position of the door, which produces the lock trigger signal when the door moves from the open to the closed position. In all cases, the access control unit (when it receives a valid access code via a keypad or a remote unit) provides the trigger to unlock the slide-bar. Examples of keypad and remote controlled access control units are described in U.S. Pat. Nos. 5,617,082, 6,359,547, and application number US2003/0234719A1.

In the case where a keypad lock mounted to the vending machine is used to access the motor control as described in the patent numbers above, the keypad lock will offer a simple user interface of keys (such as 12 access buttons) and LED lights and/or an LCD display to help the user enter access control commands, enter additional access codes, check the health of the battery, etc. Another alternative access control input may the vending machine selection buttons.

In the event an access control unit is desired that has no point of attack, a wireless remote control device may be used. Such a wireless access device is also described in U.S. Pat. No. 5,617,082, and this device also offers a battery-saver feature to reduce power consumption of the lock as it is waiting to receive an access code transmission. Two examples of wireless mediums used for this device are radio frequency and infrared. In radio frequency, the antenna of the access electronics must be in range of where the remote transmitter is used. In infrared, the infrared pin diode must be in optical range of where the remote transmitter is used. This battery saver feature can be utilized in a number ways: a) full-time when batteries are used to power the lock; b) not at all when the power to the lock is a DC power source; c) a combination of the two modes, wherein power saver mode is used when it is not expected that the lock will be immediately accessed or re-locked, and full-power mode when it is expected that the lock may be immediately accessed or re-locked. One less desirable feature of the battery saver feature is a time-delay reaction to the lock/unlock access input. The advantage to the dual mode of operation is to take advantage of the power-saver during the long time periods the lock most likely is not being locked or unlocked, and to take advantage of the full power mode to react the fastest to the lock/unlock access control signal.

The wireless access control device may take on one of many forms, such as a remote transmitter with a single access code transmit button. When the single transmitter button is pressed, the complete access code is instantly transmitted to the access control receiver, such as described in application US2003/0234719A1. Or alternately, the wireless device may use a biometric input such as fingerprint ID to replace a single button as the interface device.

The remote unit can also be a unit with several keypad buttons made up of several digits (for example, 0-9) to allow a user to enter multiple number of button input combinations to make up an access code. As each button is pressed, an individual unique code representing that button is transmitted to the access control unit. The order and combination of the codes received from the remote make up the access code for the vending machine. An example of such a device is known as a universal remote control unit for a television and/or other consumer electronics. Such units typically contain a 0-9 keypad; in these devices each key press results in a unique code transmission. The combination and order of the button presses (for example, 5 presses consisting of 1-3-5-7-9) will make up a unique access code transmission to the access control unit.

In the example above using the universal remote control unit, a problem exists with annunciation and user friendly operation of the lock. For example, the universal remote typically contains only an LED light indicating a button was pressed and a code was transmitted, but there is no consideration or confirmation that such key press of a particular code was received by the access control unit. Thus, this invention offers two possible solutions to this problem.

1. The access control unit can contain annunciation such as LED lights, an LCD display or an audio annunciator (just for a few examples) to provide feedback for the user as to exactly how many keypresses are being received by the remote transmitter. Note, these annunciations do not give any positive or negative feedback of whether the code received was valid or invalid, only that it was received. It will also attempt to annunciate the order that each code is received. For example, if the expected code is 5 digits in length, the annunciator may attempt to either light or un-light an LED for each code received, providing both feedbacks that the code was received and what receiving sequence this code was in as it was received. Typically, this annunciation would be located such that it can be viewed from just in front of the door (from 0 to 10 feet back from the door). In addition, other messages may be displayed such as the complete correct code was received, an incorrect complete code was received, the battery is low, an incorrect button was pressed, the mechanism should be unlocking, etc.

2. The access control unit can contain a transmission system (typically the same transmission medium as the remote unit) and the remote transmission unit can contain a wireless receiver system to receive the annunciation messages from the access control unit. The same annunciation components such as LED's, LCD, and/or audio indicators can be used at the remote unit. Thus, the user would transmit a code via the control unit, if received the access control would transmit back a confirmation to the remote unit, the remote unit will display an annunciation message to the user that the code was received. In addition, other messages may be displayed such as the complete correct code was received, an incorrect complete code was received, the battery is low, an incorrect button was pressed, the mechanism should be unlocking, etc.

This lock system can be power either by battery source or an AC or DC power source. If batteries are used, it is assumed they are mounted inside the enclosure and not accessible while the door is locked. The batteries shall be monitored for their health and the health will be measured and annunciated to the user as the enclosure is being accessed or locked (also described in U.S. Pat. No. 6,359,547). The batteries will usually be alkaline non-recharge type, although rechargeable types are possible to use.

In the event the batteries are to low to operate the unit, the preferred embodiment has a power input port that will accept a back-up power supply source to power the lock to allow the lock mechanism to unlock if a correct access code is received. This port does not provide a hotwire to over-ride the access control system of the lock. Once such battery-back-up unit is described in TriTeq U.S. patent application Ser. No. 60/523,505. Or, in some cases it may be possible to use a simple 9-volt battery.

The lock also provides an over-ride system in case the electronics fails (either the access control or the motor control unit) by providing access to the motor wires if the enclosure is drilled in a certain location. Once gaining access to these wires, the motor can be energized independent of the access control and motor control circuits and the slide-bar will retract so the door can be opened. This will allow the faulty lock components replacement without serious damage of the enclosure primary structure.

What is claimed:

1. A locking system for vending machines and the like wherein a door is locked and unlocked to a cabinet, comprising in combination, a motor means carried either by the door or cabinet, said motor means rotatably connected to a sliding mechanical linkage means having locked and unlocked positions, and control means for driving said motor to slide said linkage means from the locked to the unlocked position.

2. A locking system as claimed in claim 1, wherein said motor means is driven to slide said linkage from the unlocked to the locked position.

3. A locking system as claimed in claim 1, wherein said motor is a two-direction reversible motor.

4. A locking system as claimed in claim 1, wherein said locked position of said slide linkage is force resisting.

5. A locking system as claimed in claim 1, wherein said motor means drives said mechanical slide linkage means through gear reduction means.

6. A locking system as claimed in claim 5, wherein said gear reduction means includes first reduction gears, and a second gear reduction means.

7. A locking system as claimed in claim 6, wherein said second gear reduction means includes a worm gear and a helical gear.

8. A locking system as claimed in claim 7, wherein said helical gear is interfaced to at least 2 teeth of the worm gear.

9. A locking system as claimed in claim 2, wherein said motor means includes an access control means.

10. A locking system as claimed in claim 9, wherein said access control means is remotely operable.

11. A locking system as claimed in claim 9, including an override means for energizing said motor independent of said motor control means and access control means.

12. A locking system as claimed in claim 9, wherein the control means and motor are powered by a battery source.

13. A locking system as claimed in claim 9, wherein position switch means provides a lock trigger signal for energizing said motor to lock the slide linkage means.

14. A locking system as claimed in claim 9, wherein said access control means is operated by an access input means carried by the door or cabinet.

15. A locking system as claimed in claim 4, wherein sensing means is included for said motor to detect motor current and either reverse the motor direction or deenergize the motor upon reaching predetermined current levels.

16. A locking system as claimed in claim 9, wherein said access control means is operable only by input of a unique preset access code signal.

17. A method of unlocking a door to a cabinet wherein mechanical slide means is carried by either the door or cabinet and mechanical linkage means moves the slide means for unlocking the door with the cabinet comprising providing motor means with an electronic motor control to drive the mechanical linkage means between a force resisting locked position and an open position and powering said motor to drive the linkage thereby unlocking the slide means.

18. A method as claimed in claim 17, including providing microcomputer means for directing operation of said electronic motor control and motor.

19. A method as claimed in claim 18, wherein access control means is provided including provision for operating said locking system external to the door and cabinet.

20. A locking system as claimed in claim 9, wherein said control includes a battery saver sleep mode and an operational mode upon input of an access signal.

21. A locking system for vending machines and the like wherein a door is locked and unlocked to a cabinet on which the door is pivotally mounted, comprising in combination, a slide means carried either by the door or cabinet, mechanical linkage means for moving the slide means for unlocking the door from the cabinet, a motor means connected for driving the mechanical linkage means from force resisting locked position to open position, and a motor control for operating the motor to drive the mechanical linkage means to unlock the slide means between the door and cabinet.

22. A locking system as claim in claim 21, wherein said motor is further rotatably connected for driving the mechanical linkage from open position to force resisting locked position and said motor control operates the motor to drive the mechanical linkage means to lock the slide means between the door and cabinet.

23. A locking system for vending machines and the like wherein a door is locked and unlocked to a cabinet on which the door is pivotally mounted, comprising in combination, a slide means carried either by the door or cabinet, mechanical linkage means for moving the slide means for locking and unlocking the door with the cabinet, a motor means rotatably connected for driving the mechanical linkage means to force resisting locked position and open position, and an electronic motor control for operating the motor to drive the mechanical linkage means to lock and unlock the slide means between the door and cabinet.

24. A locking system as claimed in claim 23, wherein said motor is reversible and operable in two directions to move the slide means.

25. A locking system as claimed in claim 23, wherein said motor is reversible and operable in one direction to move the slide means.

26. A locking system as claimed in claim 23, wherein the electronic motor means includes a microcomputer for directing operation of said motor.

27. A locking system as claimed in claim 21, wherein said slide means is a push-pull cable.

28. A locking system as claimed in claim 21, wherein said slide means is a push-pull rod.

29. A locking system as claimed in claim 21, wherein said mechanical linkage and slide means is gear driven.

30. A locking system as claimed in claims 1, 17, 21 and 23, wherein said linkage means includes a plurality of latch means engagable for the lock and unlock positions.

31. A locking system as claimed in claim 30, wherein said latch means includes hook and slot type latches.

32. A method of unlocking a door to a cabinet comprising providing rotational force generating means carried by either the door or cabinet, connecting mechanical force conversion means to the rotational force generating means for converting the rotational force to a linear drive force, attaching the mechanical force conversion means to a latch mechanism operable to slideably move between a locked and unlocked position and controllably driving said sliding latch mechanism from said locked to the unlocked position.

33. A locking system as claimed in claim 21, wherein said rotational force means includes an access control means.

34. A locking system as claimed in claim 33, wherein said access control means is remotely operable.

35. A locking system as claimed in claim 33, including an override means for energizing said motor independent of said motor control means and access control means.

36. A locking system as claimed in claim 33, wherein the control means and motor are powered by a battery source.

37. A locking system as claimed in claim 33, wherein position switch means provides a lock trigger signal for energizing said motor to lock the slide linkage means.

38. A locking system as claimed in claim 23, wherein said motor means includes an access control means.

39. A locking system as claimed in claim 38, wherein said access control means is remotely operable.

40. A locking system as claimed in claim 38, including an override means for energizing said motor independent of said motor control means and access control means.

41. A locking system as claimed in claim 38, wherein the control means and motor are powered by a battery source.

42. A locking system as claimed in claim 38, wherein position switch means provides a lock trigger signal for energizing said motor to lock the slide linkage means.

43. A method of locking a door to a cabinet comprising providing rotational force generating means carried by either the door or cabinet, connecting mechanical force conversion means to the rotational force generating means for converting the rotational force to a linear drive force, attaching the mechanical force conversion means to a latch mechanism operable to slideably move between an unlocked and locked position and controllably driving said sliding latch mechanism from said unlocked to the locked position.

44. A locking system as claimed in claim 43, wherein said rotational force means is a motor means and includes an access control means.

45. A locking system as claimed in claim 44, wherein said access control means is remotely operable.

46. A locking system as claimed in claim 44, including an override means for energizing said motor independent of said motor control means and access control means.

47. A locking system as claimed in claim 44, wherein the control means and motor are powered by a battery source.

48. A locking system as claimed in claim 32, wherein said rotational force means is a motor means and includes an access control means.

49. A locking system as claimed in claim 48, wherein said access control means is remotely operable.

50. A locking system as claimed in claim 48, including an override means for energizing said motor independent of said motor control means and access control means.

51. A locking system as claimed in claim 48, wherein the control means and motor are powered by a battery source.

52. A locking system as claimed in claim 48, wherein position switch means provides a lock trigger signal for energizing said motor to lock the slide linkage means.
